(19) United States
(12) Patent Application Publication
(10) Pub. No.: US 2009/0158940 A1
(43) Pub. Date: Jun. 25, 2009

(54) KITCHEN APPLIANCE FOR HEATING FOODSTUFF

(75) Inventors: Dorian Archer, Richmond, VA (US); Michael Garman, Midlothian, VA (US); Zhang Chun Feng, Guan Dong (CN)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: Hamilton Beach Brands, Inc., Glen Allen, VA (US)

(21) Appl. No.: 11/959,867

(22) Filed: Dec. 19, 2007

(51) Int. Cl. A47J 37/12

(52) U.S. Cl. 99/403

(57) ABSTRACT

A kitchen appliance for heating foodstuff that includes a body having a bottom, a sidewall extending therefrom to define a generally hollow interior and a body rim defining an opening for accessing the interior thereof. The interior is capable of retaining the foodstuff therein. The body includes a pour spout integrally formed within the sidewall and a heating element in a thermal relationship with the body to heat the foodstuff within the body. A lid is removably mountable to the body rim of the body. The lid is sized and shaped to cover the opening of the body when placed on the body rim.

### BACKGROUND OF THE INVENTION

The present invention is directed to a kitchen appliance for heating foodstuff and, more particularly, to a kitchen appliance, skillet or other similar device that allows a user to drain liquid, but retain solid foodstuff, from within the tilted or partially inverted appliance when a lid is securely attached to a body of the appliance.

Cooking pots or kettles, particularly those used for stewing or cooking soups, are well known in the art. Such containers generally include a circular body enclosing an interior capable of retaining foodstuff therein and a lid removably positioned on top of the container body. The lids of such containers may include one or more small holes or passageways to allow liquid or steam to escape without having to remove the lid from the body. In order to cook or heat the foodstuff to the desired temperature, a user must place the cooking pot on a separate stove or cook top. Once the user determines that the foodstuff is properly cooked, the user must then lift the cooking pot from the stove and tilt the pot towards a sink or other drainage basin such that excess liquid can be drained from the body of the pot.

During this use of conventional cooking pots, problems arise when the user must tilt the pot while simultaneously holding the lid firmly on top of the pot. Often, steam that escapes from the one or more small holes or passageways in the lid as the liquid drains from the pot may either distract or harm the user such that the user may drop the pot. Further, it is often difficult for the user to maintain the lid tightly on top of the pot while the fluid is flowing from out of the pot through the one or more holes of the lid. Often, the user is not able to firmly hold the lid on top of the tilted pot and a quantity of the cooked foodstuff or liquid may inadvertently flow out of the pot. As a result, conventional cooking pots create a potential serious safety hazard for the user. Further, since the conventional cooking pots do not include an integral heat source, a user cannot cook or heat foodstuff without the assistance of a separate stove or cook top. For instance, when a user is traveling, camping or on vacation, the user must be near a stove or cook top to heat the contents within the conventional cooking pot. Thus, foodstuff cannot be cooked within the pot unless a user is near a conventional stove or cook top.

Therefore, it would be desirable to create a cooking pot or kitchen appliance such that liquid foodstuff can be drained from within the kitchen appliance without creating a potential safety hazards as described above. Specifically, it would be desirable to create a kitchen appliance with an integral pour spout that also includes locking latches such that the lid can securely be mounted to the body of the kitchen appliance when the kitchen appliance is tilted or partially inverted without creating a safety hazard for the user. Further, it would be desirable to create a cooking pot or kitchen appliance with an integral heating element such that the kitchen appliance or cooking pot can be used at virtually any location, such as while camping or on vacation, without requiring the need of a conventional stove or cook top.

### BRIEF SUMMARY OF THE INVENTION

Briefly stated, the present invention is directed to a kitchen appliance for heating foodstuff. The kitchen appliance includes a body having a bottom, a sidewall extending therefrom to define a generally hollow interior and a body rim defining an opening for accessing the interior thereof. The interior is capable of retaining the foodstuff therein. The body includes a pour spout integrally formed in the sidewall and a heating element in a thermal relationship with the base to heat the foodstuff within the body. A lid is removably mountable to the body rim of the body. The lid is sized and shaped to cover the opening of the body when placed on the body rim.

In another aspect, the present invention is directed to a kitchen appliance for heating foodstuff. The kitchen appliance includes the base having a top surface and a bottom surface. A body has a bottom, a sidewall extending therefrom to define it generally hollow interior and a body rim defining an opening for accessing the interior thereof. The interior is capable of retaining the foodstuff therein. The bottom of the body is integrally formed with the top surface of the base. A heating element is in a thermal relationship with the base to heat the foodstuff within the body. A lid is removably mountable to the body rim of the body. A lid is sized and shaped to cover the opening of the body when placed on the body rim. Further, at least one locking latch is pivotably mountable on at least a portion of the body to securely attach the lid to the body.

### BRIEF DESCRIPTION OF THE SEVERAL VIEWS OF THE DRAWINGS

The foregoing summary, as well as the following detailed description of preferred embodiments of the present invention, will be better understood when read in conjunction with the appended drawings. For the purpose of illustrating the invention described in the present application, there are shown in the drawings, embodiments which are presently preferred. It should be understood, however, that the invention is not limited to the precise arrangements and instrumentalities shown. In the drawings:

FIG. 1 is a front right top perspective view of a kitchen appliance in accordance with a first preferred embodiment of the present invention;

FIG. 2 is a front elevation view of the kitchen appliance shown in FIG. 1;

FIG. 3 is a left side elevation view of the kitchen appliance shown in FIG. 1, with the right side being a mirror image;

FIG. 4 is a rear elevation view of the kitchen appliance shown in FIG. 1;

FIG. 5 is a top plan view of the kitchen appliance shown in FIG. 1;

FIG. 6 is a bottom plan view of the kitchen appliance shown in FIG. 1;

FIG. 7 is a front right top perspective view of a kitchen appliance in accordance with a second preferred embodiment of the present invention;

FIG. 8 is a front elevation view of the kitchen appliance shown in FIG. 7;

FIG. 9 is a left side elevation view of the kitchen appliance shown in FIG. 7; with the right side being a mirror image;

FIG. 10 is a rear elevation view of the kitchen appliance shown in FIG. 7;

FIG. 11 is a top plan view of the kitchen appliance shown in FIG. 7;

FIG. 12 is a bottom plan view of the kitchen appliance shown in FIG. 7;

FIG. 13 is a front right top perspective view of a kitchen appliance in accordance with a third preferred embodiment of the present invention;

FIG. 14 is a front elevation view of the kitchen appliance shown in FIG. 13;

FIG. 15 is a right side elevation view of the kitchen appliance shown in FIG. 13;

FIG. 16 is a rear elevation view of the kitchen appliance shown in FIG. 13;

FIG. 17 is a top plan view of the kitchen appliance shown in FIG. 13;

FIG. 18 is a bottom plan view of the kitchen appliance shown in FIG. 13;

FIG. 19 is a front right top perspective view of a kitchen appliance in accordance with a fourth preferred embodiment of the present invention;

FIG. 20 is a front elevation view of the kitchen appliance shown in FIG. 19;

FIG. 21 is a right side elevation view of the kitchen appliance shown in FIG. 19;

FIG. 22 is a rear elevation view of the kitchen appliance shown in FIG. 19;

FIG. 23 is a top plan view of the kitchen appliance shown in FIG. 19;

FIG. 24 is a bottom plan view of the kitchen appliance shown in FIG. 19.

### DETAILED DESCRIPTION OF THE INVENTION

Certain terminology is used in the following description for convenience only and is not limiting. The words “right”, “left”, “lower” and “upper” designate directions in the drawings to which reference is made. The words “inwardly” and “outwardly” refer to directions toward and away from, respectively, the geometric center of the kitchen appliance and designated parts thereof. The terminology includes the above-listed words, derivatives thereof and words of similar import.

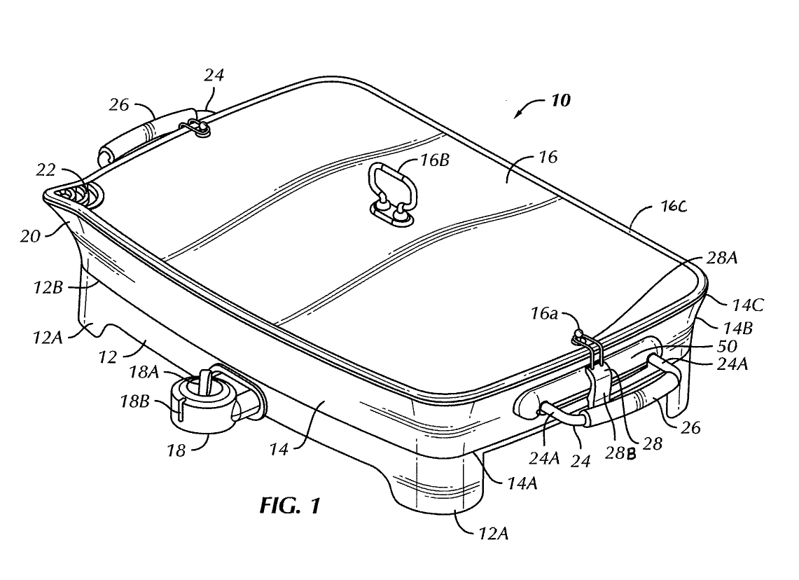

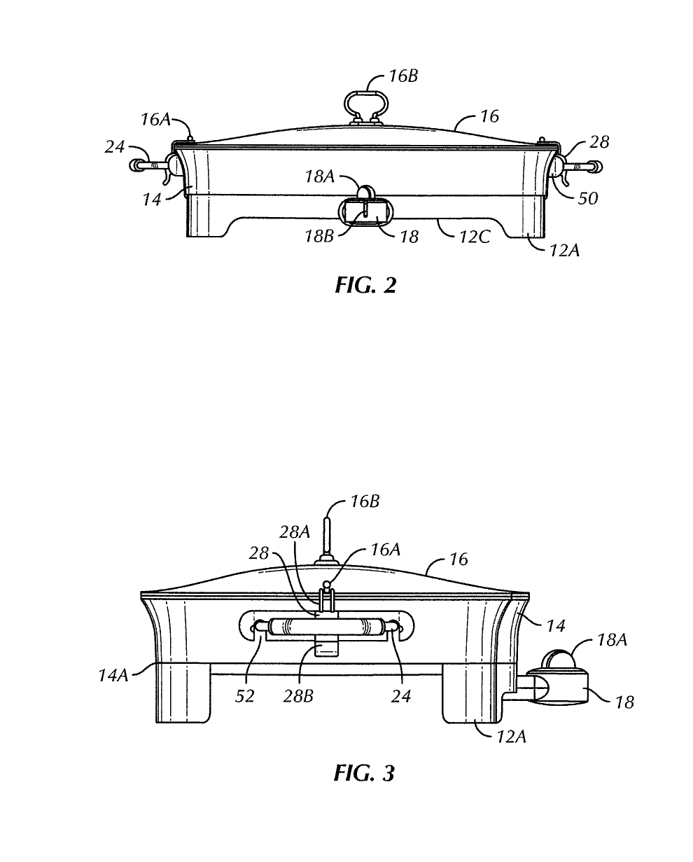

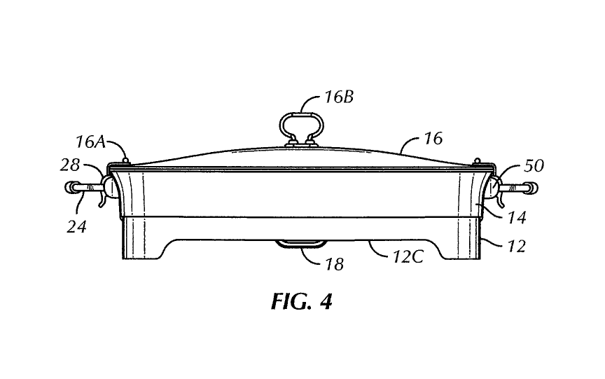

Referring to the drawings in detail, wherein like numerals are used to indicate like elements throughout, there is shown in FIGS. 1-6 a first preferred embodiment of a kitchen appliance, generally designated 10, for heating foodstuff (not shown) in accordance with the present invention. The kitchen appliance 10 is preferably in the form of a conventional skillet, but could be other products such as a kettle, pot, food container or virtually any other cookware used to hold, heat or cook foodstuff without departing from the spirit and scope of the invention. The kitchen appliance 10 preferably includes a base 12, a body 14, and a lid 16.

Referring to FIGS. 1-4, the body 14 has a generally flat bottom 14A and a generally continuous sidewall 14B extending upwardly therefrom to define a generally hollow interior. Further, the body 14 has a body rim 14C on the upper edge of the sidewall 14B defining an opening for accessing the interior thereof. The interior is capable of retaining the foodstuff therein. The body 14 is generally rectangular in shape when viewed from below or above and includes three slightly rounded corners. However, it is understood by those skilled in the art that the body 14 could be some other shape if desired. Preferably, the body 14 is formed of a high strength, lightweight material, such as a metallic material, capable of holding foodstuff therein and withstanding the high temperatures required to heat and cook foodstuff. However, it is understood by those skilled in the art that the shape and material used to construct the body 14 can be modified without departing from the spirit and scope of the invention. For example, the body 14 may be constructed of a ceramic or polymeric material that allows the body 14 to retain foodstuff therein, that is capable of withstanding the high temperature requirements and also providing rigidity to the kitchen appliance 10.

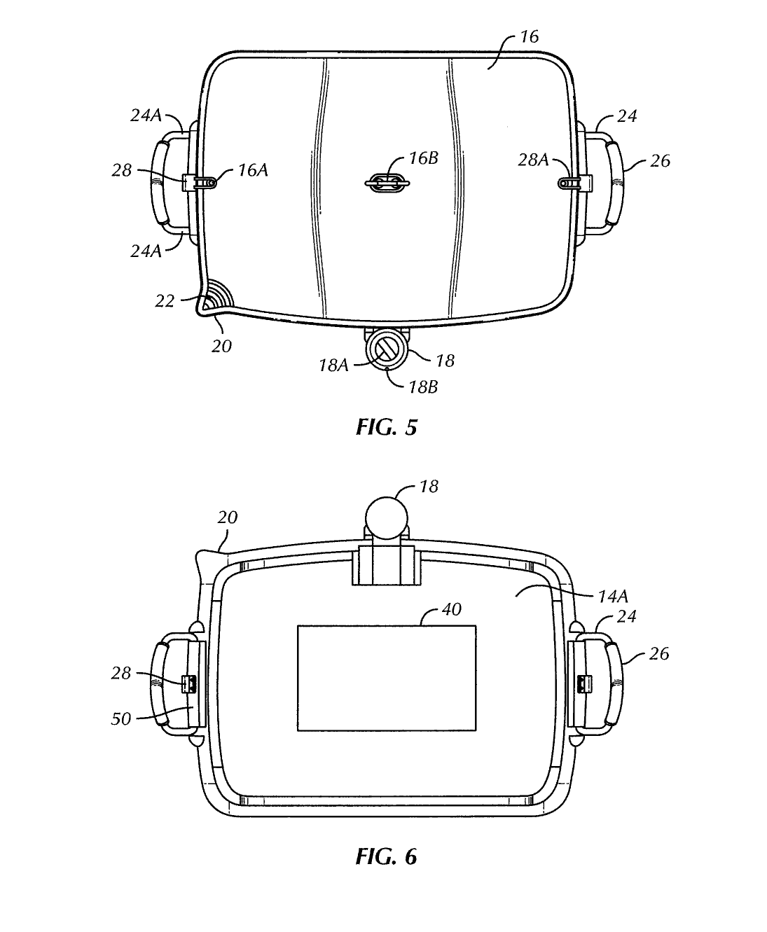

The body 14 includes a pour spout 20 integrally formed at the fourth corner of the sidewall 14B of the body 14. As seen in FIGS. 1 and 5, when viewed from above or below the pour spout 20 generally outwardly extends beyond the sidewall 14B of the body 14 slightly further than if a rounded corner was located therein. The pour spout 20 is designed to provide a passageway or guide for liquid exiting from within the body 14 when the kitchen appliance 10 is either tilted or partially inverted. Preferably, the pour spout 20 is constructed of the same lightweight, high strength material that the body 14 is constructed of to maintain the rigidity and durability of the kitchen appliance 10. However, it is understood by those skilled in the art that the pour spout 20 may be constructed of a different material from that used to construct the body 14 without departing from the spirit and scope of the invention. The pour spout 20 is generally v-shaped when viewed from below or above, but it is understood by those skilled in the art that the size and shape of the pour spout 20 can be modified without departing from the spirit and scope of the invention. For example, the pour spout 20 may include two small slots or guides that allow liquid foodstuff to exit at different locations within the pour spout 20. Further, it is within the spirit and scope of the invention that the body 14 include more than one pour spout 20 or that the pour spout 20 is located on a side edge, and not a corner, of the body 14.

The body 14 further includes at least one body handle 24 pivotably mountable to the sidewall 14B of the body 14. Preferably, the at least one body handle 24 is pivotable between a first horizontal position (as shown in FIGS. 1-6) through a second downward, vertical position (not shown). The at least one body handle 24 is preferably U-shaped such that two ends 24A of the at least one body handle 24 are pivotably attached to the body 14. A body extension 50 extends outwardly beyond the sidewall 14B of the body 14 to partially enclose and engage the first ends 24A of the body handle 24. The body extension 50 includes slots 52 to provide a pathway for the body handle 24 to pivot from the first position through the second position and vice-versa. Further, the at least one body handle 24 preferably includes a gripping section 26 approximate a midsection of the at least one body handle 24 to provide a soft gripping location for a user.

The body extension 50 is preferably arced or tapered in shape to provide a smooth transition from the sidewall 14B of the body 14. Preferably, the kitchen appliance 10 of the present invention includes two pivotable body handles 24 and two body extensions 50 on opposite sides of the body 14. However, it is understood by those skilled in the art that the location and number of body handles 24 and body extensions 50 can be modified without departing from the spirit and scope of the invention. For example, one or more body handles 24 or body extensions 50 may be on a front or rear surface of the body 14 without departing from the spirit and scope of the invention. Further, the body handle 24 may be sized to accept only one or two fingers departing from the spirit and scope of the invention. It is understood by those skilled in the art that the body 14 is not limited to the inclusion of the body extension 50.

As shown in FIG. 6, a heating element 40 is in a thermal relationship with the bottom 14A of the body 14 to heat the foodstuff within the body 14. Specifically, the heating element 40 is securely attached or cast into to the body 14. Preferably, the heating element 40 is a heating coil and magnesium oxide enclosed inside of a steel sheath (not shown). However, it is within the spirit and scope of the invention that the heating element 40 of the kitchen appliance 10 of the present invention be in the form of virtually any type of conventional resistant-type heating element, such as a cal-rod or mica board heating element, without departing from the spirit or scope of the invention. Those skilled in the art would understand that it is within the spirit and scope of the present invention that a different type of heating element may be used provided that the heating element 40 functions to heat the body 14 of the kitchen appliance 10. Preferably, the heating element 40 is powered by either a conventional power cord (not shown) or by batteries (not shown). However, it is understood by those skilled in the art that the electrical power may be provided to the heating element 40 in virtually any manner without departing from the spirit and scope of the invention.

The lid 16 is removeably mountable to the body rim 14C of the body 14. Preferably, a metallic band 16C extends around the periphery of the lid 16. The lid 16 is sized and shaped to fully cover the opening of the body 14 when placed on the body rim 14C. The lid 16 is preferably sized and shaped to match the shape of the body 14 when viewed from above or below. However, it is within the spirit and scope of the invention that the shape of the lid 16 may be modified to virtually any shape, such as triangular, so long as the lid 16 can properly enclose the opening of the body 14. Preferably, the lid 16 is formed of a glass material or a polymeric material such that the lid 16 is generally transparent or translucent and exhibits increased insulating characteristics. However, it is understood by those skilled in the art that the lid 16 can be formed of virtually any material, such as a metallic material, without departing from the spirit and scope of the invention.

The lid 16 includes a lid handle 16B extending from the top surface of the lid 16. The lid handle 16B is preferably sized to accept only one or two fingers to allow the lid 16 to be lifted from the body 14. However, it is within the spirit and scope of the present invention that the lid handle 16B may be pivotably mounted to the lid 16. Further, the size and shape of the lid handle 16B may be modified, such that the lid handle 16B is large enough to accommodate an entire hand, without departing from the spirit and scope of the invention. Similar to the body 14, the lid 16 includes three slightly curved corners to match the three slightly curved corners of the body 14. The lid 16 also includes a particle strainer 22 integrally formed at a fourth corner of the lid 16. The particle strainer 22 is sized and shaped to match the general size and shape of the pour spout 20 when viewed from above or below. The sidewall 14B of the body 14 and the lid 16 are complimentary sized such that the pour spout 20 and the strainer 22 are in registry when the lid 16 is positioned on the body 14

As seen in FIGS. 1 and 5, the particle strainer 22 includes a series of passageways to allow liquid or steam to escape from the interior of the body 14 without the requirement that the lid 16 be removed or partially removed from the body 14. Specifically, the particle strainer 22 allows steam or hot air to exit from the body 14 of the kitchen appliance 10 while the lid 16 is firmly attached to the body rim 14C. Further, the particle strainer 22 allows liquid foodstuff to exit the body 14 of the tilted or partially inverted kitchen appliance 10 while the lid 16 is firmly attached to the body rim 14C. Preferably, the passageways in the particle strainer 22 are formed by a series of fixed, integral or permanent bands. However, it is understood by those skilled in the art the particle strainer 22 is not limited to being fixedly or integrally mounted onto the lid 16. For example, it is within the spirit and scope of the present invention that the particle strainer may be rotatably attached to the lid 16 such that the particle strainer 22 may be opened or closed as desired by the user. Further, a particle strainer may be created by welding a separate part to the body 14. In this configuration, a regular rectangular lid could be used.

The lid 16 farther includes at least one latching post 16A and at least one locking latch 28 pivotably mountable on at least a portion of the body handle 24 to securely attach the lid 16 on to the body 14 through selectively releasable engagement with the at least one latching post 16A. The latching post 16A preferably extends vertically from a top surface of the lid 16 and includes a bulbous top portion and a shaft portion connecting the top surface of the lid 16 to the bulbous top portion. The at least one locking latch 28 includes a hook 28A, sized and shaped to engage the shaft portion of the latching post 16A, and a lever 28B integrally formed with the hook 28A to engage a portion of the body protrusion 50. The lever 28B has an inner surface shaped to conform to the outer surface of the body protrusion 50. The at least one locking latch 28 secures the lid 16 to the body 14 when the hook 28A surrounds and engages the shaft portion of the latching post 16A and the inner surface of the lever 28B frictionally engages the body protrusion 50.

Therefore, the at least one locking latch 28 selectively retains the lid 16 on the container rim 14C to inhibit leakage of the foodstuff from within the interior of the body 14. The at least one locking latch 28 is a generally conventional over-the-center clip having a hook 28A and a lever 28B, such that manipulation of the lever 28B causes engagement or release of the hook 28A of the at least one locking latch 28. Preferably, the hook 28A is selectively releasably engagable with the lid 16 with movement of the lever 28B to selectively retain the lid 16 on the body rim 14C. Specifically, it is preferred that, when in an engaged position (FIGS. 1-6), the at least one locking latch 28 retains the lid 16 on the body rim 14C, and, when in a released position (not shown), the hook 28A is removed from engagement with the latching post 16A so that the lid 16 can be removed from the body 14 in order to allow access to the interior of the body 14.

When the hook 28A is placed around the shaft portion of the latching post 16A, the lever 28B of the at least one locking latch 28 can be rotated downwardly and inwardly toward the side wall 14B of the body 14 to create a retaining force exerted by the at least one locking latch 28 on the lid 16 in order to retain the lid 16 on the body rim 14C. To release the at least one locking latch 28, the lever 28B may be rotated outwardly and upwardly with respect to the side wall 14B of the body 14 to release the retaining force. Once in this position, the hook 28A of the at least one locking latch 28 can be removed from engagement with the shaft portion of the latching post 16A to enable the lid 16 to be removed from engagement with the body rim 14C.

Preferably, the at least one locking latch 28 is removably mountable to the body 14 of the kitchen appliance 10. However, it is understood by those skilled in the art that the at least one locking latch 28 may be pivotably and securely attached to either a portion of the body 14, the body protrusion 50 or the body handle 24, without departing from the spirit and scope of the invention. Preferably, the kitchen appliance 10 of the present invention includes two latching posts 16A at opposite ends of the lid 16 to matingly engage two locking latches 28 at opposite ends of the body 14. However, it is understood by those in the art that the number, size and the shape of the at least one latching post 16A and the at least one locking latch 28 may be modified without departing from the spirit and scope of the invention.

The base 12 is permanently mounted to the bottom 14A of the body 14 to support the body 14. The base 12 has a top surface 12B and a bottom surface 12C. The bottom 14A of the body 14 is attached to the top surface 12B of the base 12 by at least one fastener (not shown). A plurality of feet 12A extend downward from the bottom surface 12C of the base 12 to support the base 12 and the kitchen appliance 10 on a variety of surfaces, such as a countertop or tabletop (not shown). The base 12 is preferably rectangular in shape when viewed from above or below. The base 12 has corners similar in shape to the corners of the body 14 and the lid 16 such that the kitchen appliance 10 has the appearance of smooth transitions around the sides of the kitchen appliance 10 and between the base 12, body 14, and lid 16. The base 12 is preferably formed of a metallic material with insulative phenolic inserts attached to the metal base 12 and includes non-slip rubber inserts attached to the phenolic inserts to aid in preventing the kitchen appliance 10 from sliding during use. However, it is understood by those skilled in the art that the base 12 may be formed of virtually any high strength, lightweight material, such as a metallic material, a polymeric material or a ceramic material, without departing from the spirit and scope of the present invention. Further, the base 12 may be formed of an insulative or non-heat transferable material, such as a ceramic material.

The base 12 further includes a temperature probe 18 operatively mounted to the base 12. The temperature probe 18 allows the user to control the temperature at which the heating element 40 heats the body of the kitchen appliance 10. The temperature probe 18 preferably extends beyond a side of the base 12 to provide the user with ease of accessibility to control the heating element 40 of the kitchen appliance 10. The temperature probe 18 includes a temperature set dial 18A and an indicator, such as a light emitting device 18B. Preferably, the temperature set dial 18A of the present invention is be rotated by the user to set the desired temperature of the heating element 40. However, it is understood by those skilled in the art that the temperature set dial 18A of the present invention may be in virtually any form, such as a push-button or remote control, without departing from the spirit and scope of the invention. The light emitting device 18B, which is preferably in the form of a light emitting diode (LED), illuminates once the thermostat is closed and the kitchen appliance 10 is drawing electric current. Alternatively, the light emitting device 18B may illuminate one the heating element 40 has reached the preset temperature desired by the user to provide a visual indication to the user when the kitchen appliance 10 is ready to cook or heat foodstuff.

It is understood by those skilled in the art that the present invention is not limited to the above-described temperature probe 18A and light emitting device 18B and may operate without a temperature probe 18 and light emitting device 18B. Further, it is understood by those skilled in the art that the size, shape and location of the temperature probe 18 and light emitting device 18B can be modified without departing from the spirit and scope of the invention. For example, the heating element 40 of the kitchen appliance 10 the present invention may be controlled via remote control (not shown) or a control dial mounted to the lid 16 or the body 14. It is understood by those skilled in the art that the body 14 and the base 12 may be separable for cleaning purposes. However, it is also understood by those skilled in the art that the body 14 may be integrally mountable to the base 12.

In operation, a user would remove the kitchen appliance 10 of the present invention from the box (not shown) from which the kitchen appliance 10 was stored or transported. The kitchen appliance 10 would then be placed on a countertop, tabletop or other supporting surface (not shown) such that the plurality of feet 12A of the base 12 support the weight of the kitchen appliance 10. Next, the user would pivot the base portion 28B of the locking latches 28 upwardly such that the hook 28A of the locking latches 28 no longer engages the latching posts 16A. The user may then place the locking latches 28 to the side such that they are out of the way. Next, the user would supply power to the heating element 40 via the power cord (not shown) or batteries (not shown). The user would then rotate the temperature set dial 18A to the desired preheat temperature of the heating element 40. The light emitting device 18B would illuminate to indicate to the user that the kitchen appliance 10 is drawing electric current and beginning to heat up. Next, the user would remove the lid 16 from the body rim 14C of the body 14 by lifting upwardly on the lid handle 16B. Next, the user would put the foodstuff within the interior of the body 14 and place the lid 16 back onto the body rim 14C of the body 14. The user would then take the locking latches 28 such that the bands 28A would be mounted around the shaft portions of the latching post 16A and pivot the base portion 28B of the locking latches 28 downward to lock the locking latches 28 onto the latching post 16A and the body extension 50 of the body 14. Next, the user would wait until the foodstuff appeared to be cooked within the kitchen appliance 10.

Then, if the user desired to remove some of the cooked liquid from within the body 14 of the kitchen appliance to separate the liquid from the cooked foodstuff, the user would tilt the entire kitchen appliance 10 to a certain degree to allow liquid foodstuff to pass from the pour spout 20 of the body 14 through the particle strainer 22 of the lid 16 into a sink or other container (not shown). In this configuration, the safety hazards would no longer be a concern since the lid 16 is securely mounted to the body 14 of the kitchen appliance 10 via the locking latches 28 and the latching post 16A. Once the user drains the desired liquid from the kitchen appliance 10, the user would put the kitchen appliance 10 back down flush on the supporting surface. Next, the user would remove the locking latches 28 from the latching posts 16A and the body protrusions 50 such that the lid 16 could be removed from the body rims 14C of the body. Accordingly, this device would allow the user to cook foodstuff within the kitchen appliance 10 without the need for a separate stove or cook top. Additionally, if the body 14 and base 12 are separable or removably mountable, the body 14 and base 12 may be separated to assist the user in cleaning the kitchen appliance 10.

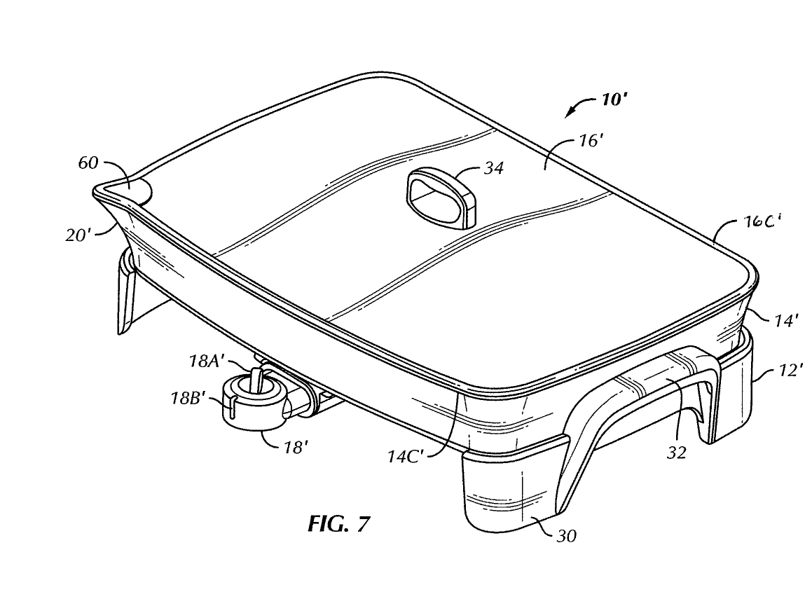

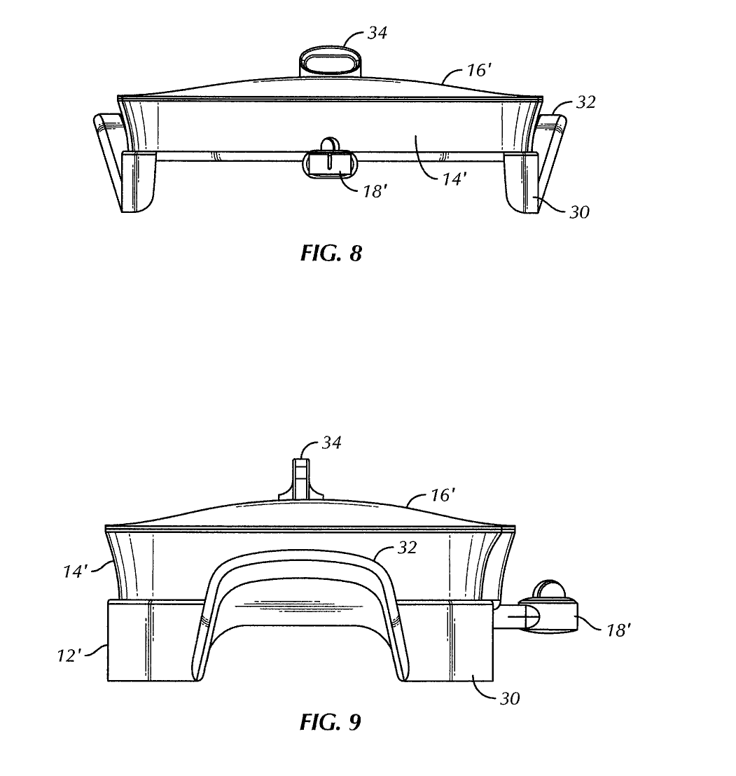

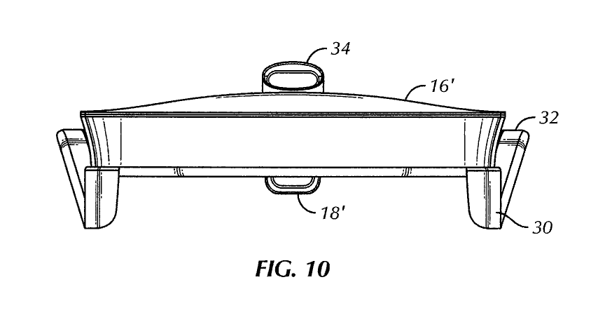

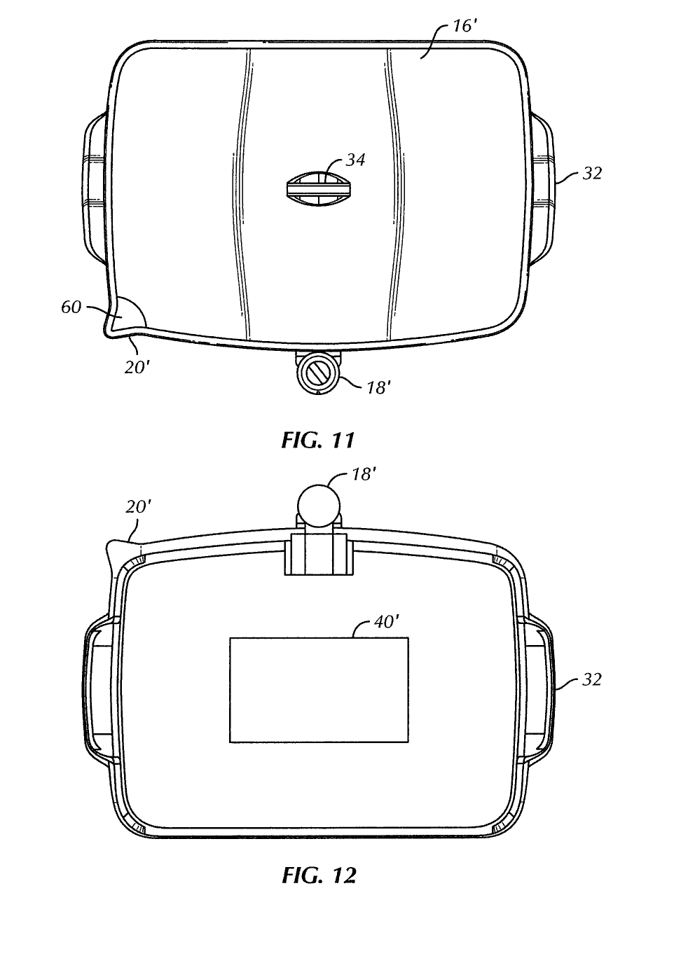

Referring to FIGS. 7-12, a second preferred embodiment of the kitchen appliance 10′ is shown, including like reference numerals to indicate like elements and a prime symbol (′) distinguishing the reference numerals of the second preferred embodiment from the first preferred embodiment. The second preferred embodiment of the kitchen appliance 10′ is substantially similar to the first preferred embodiment of the kitchen appliance 10. Similar to the first preferred embodiment, the second preferred embodiment of the kitchen appliance 10′ is used for heating foodstuff. The kitchen appliance 10′ of the second preferred embodiment also includes a base 12′, a body 14′, a lid 16′, and a temperature probe 18′. Further, the body 14′ of the second preferred embodiment also includes a pour spout 20′, similar to the first preferred embodiment of the kitchen appliance 10. The kitchen appliance 10′ of the second preferred embodiment also includes a heating element 40′ similar in size, shape, location and function to the heating element 40 of the kitchen appliance 10 of the first preferred embodiment. However, the kitchen appliance 10′ of the second preferred embodiment does not include a strainer, pivotable body handles, latching posts or locking latches. Further, the lid 16′ of the second preferred embodiment is not identical to or interchangeable with the lid 16 of the second preferred embodiment. However, the lids 16, 16′ could be designed to be identical if desired by the user or manufacturer.

As seen in FIGS. 7-12, the plurality of feet 30 of the kitchen appliance 10′ of the second preferred embodiment are modified in size and shape from the plurality of feet 12A of the kitchen appliance 10 of the first preferred embodiment. Further, handles 32 of the kitchen appliance 10′ of the second preferred embodiment are molded onto the side portions of the body 14′ and the base 12′. The kitchen appliance handles 32 of the second preferred embodiment of the kitchen appliance 10′ are not pivotably mounted to the body 14′ or the base 12′. Further, the lid 16′ of the kitchen appliance 10′ of the second preferred embodiment includes a particle stopper 60 in a corner of the lid 16′ where the particle strainer 22 of the kitchen appliance 10 of the first preferred embodiment would have been located. The particle stopper 60 prevents liquid from being drained from the pour spout 20′ of the body 14′ unless the lid 16′ is removed from the body rim 14C′ of the present invention. Further, the lid handle 34 of the lid 16′ is sized and shaped differently than the lid handle 16B of the first preferred embodiment.

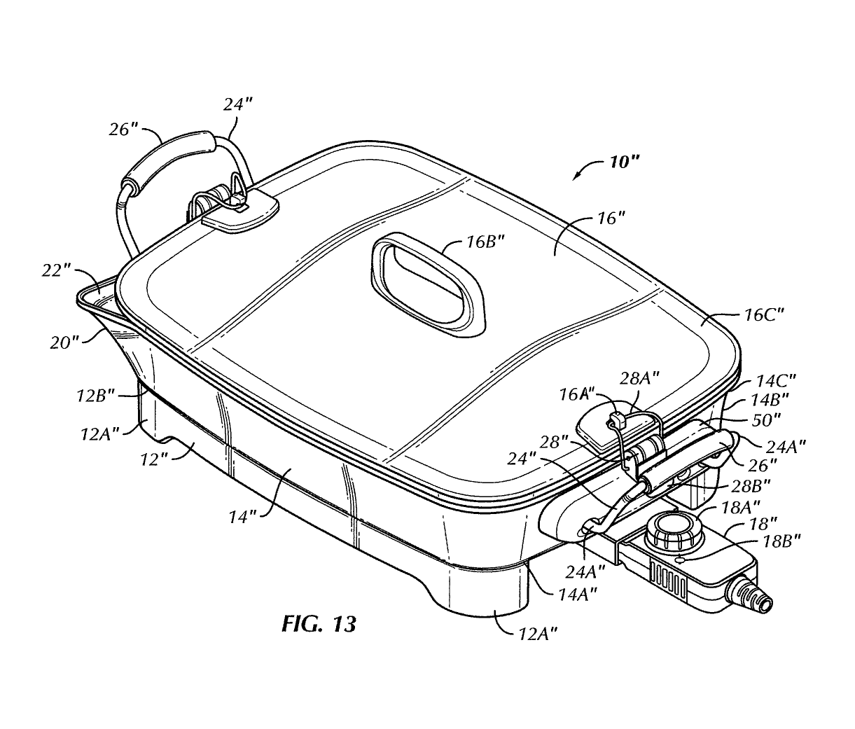

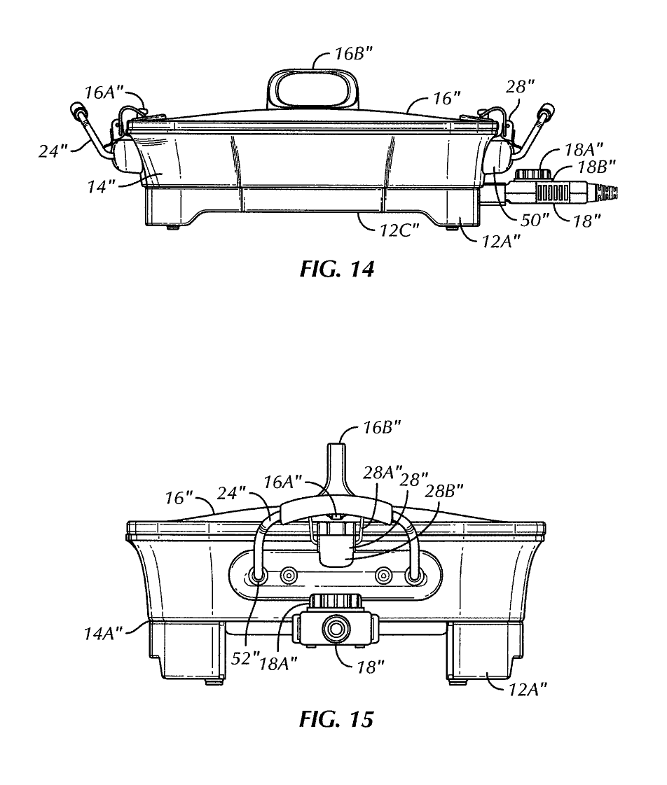

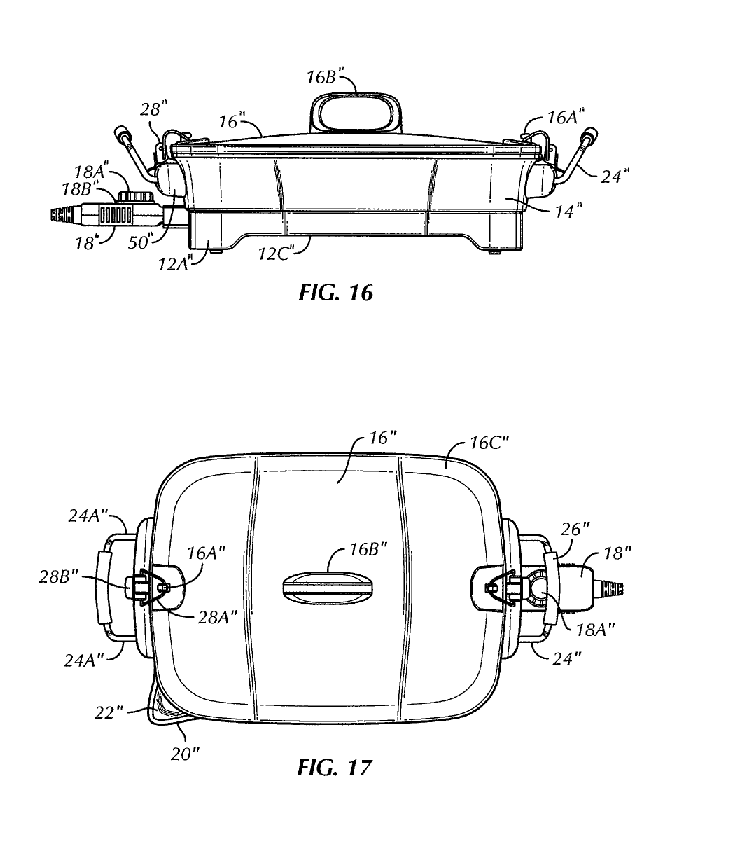

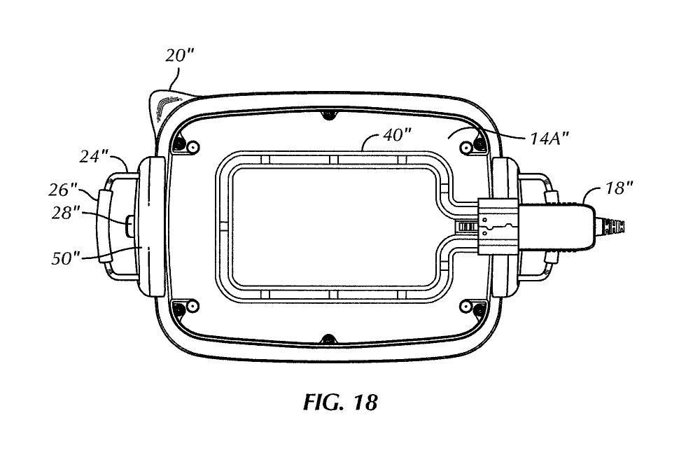

Referring to FIGS. 13-18, a third preferred embodiment of the kitchen appliance 10″ is shown, including like reference numerals to indicate like elements and two prime symbols (″) distinguishing the reference numerals of the third preferred embodiment from the first and second preferred embodiments. The third preferred embodiment of the kitchen appliance 10″ is substantially similar to the first preferred embodiment of the kitchen appliance 10. Similar to the other preferred embodiment, the third preferred embodiment of the kitchen appliance 10″ is used for heating foodstuff. The kitchen appliance 10″ of the third preferred embodiment also includes a base 12″, a body 14″, a lid 16″, and a temperature probe 18″. Further, the body 14″ of the third preferred embodiment also includes a pour spout 20″, similar to the other preferred embodiment of the kitchen appliance 10, 10′. The kitchen appliance 10″ of the third preferred embodiment also includes a heating element 40″ similar in size, shape, location and function to the heating element 40 of the kitchen appliance 10 of the first preferred embodiment. However, the kitchen appliance 10″ of the third preferred embodiment does not include a strainer or pivotable body handles. Further, the lid 16″ of the third preferred embodiment does not extend to cover the pour spout 20″ of the body 14″ and the temperature probe 18″ extends from the body 14″.

As seen in FIGS. 13-18, the body 14″ of the third preferred embodiment includes at least one body handle 24″ angularly mounted to the sidewall 14B″ of the body 14″. The at least one body handle 24″ is preferably U-shaped such that two ends 24A″ of the body handle 24″ are fixedly attached to the body 14″. A body extension 50″ extends outwardly beyond the sidewall 14B″ of the body 14″ to enclose and engage the first ends 24A″ of the at least one body handle 24″. Further, the body handle 24″ preferably includes a gripping section 26″ approximate a midsection of the body handle 24″ to provide a soft gripping location for a user. Preferably, the kitchen appliance 10″ includes two body handles 24″ and two body extensions 50″ on opposite sides of the body 14″.

The lid 16″ of the third preferred embodiment includes at least one latching post 16A″ and at least one locking latch 28″ pivotably mountable on at least a portion of the body extension 50″ to securely attach the lid 16″ on to the body 14″ through selectively releasable engagement with the at least one latching post 16A″. The latching post 16A″ preferably extends vertically from a top surface of the lid 16″ and includes a hook-shaped top portion and a shaft portion connecting the top surface of the lid 16″ to the hook-shaped top portion. The at least one locking latch 28″ includes a hook 28A″, sized and shaped to engage the hook-shaped top portion of the latching post 16A″, and a lever 28B″ operatively attached to a spring (not shown) to tighten and release the hook 28A″. The at least one locking latch 28″ secures the lid 16″ to the body 14″ when the hook 28A″ surrounds and engages the hook-shaped top portion of the latching post 16A″ and lever 28B″ is rotated away from the hook 28A″ to tighten the hook 28A″ around the latching post 16A″.

Thus, the at least one locking latch 28″ selectively retains the lid 16″ on the container rim 14C″ to inhibit leakage of the foodstuff from within the interior of the body 14″. The at least one locking latch 28″ is a generally conventional over-the-center clip having a hook 28A″ and a lever 28B″, such that manipulation of the lever 28B″ causes engagement or release of the hook 28A″ of the at least one locking latch 28″. Preferably, the hook 28A″ is selectively releasably engagable with the lid 16″ with movement of the lever 28B″ to selectively retain the lid 16″ on the body rim 14C″. Specifically, it is preferred that, when in an engaged position (FIGS. 13-18), the at least one locking latch 28″ retains the lid 16″ on the body rim 14C″, and, when in a released position, the hook 28A″ is removed from engagement with the latching post 16A″ so that the lid 16″ can be removed from the body 14″ in order to allow access to the interior of the body 14″.

When the hook 28A″ is placed around the hook-shaped top portion of the latching post 16A″, the lever 28B″ of the at least one locking latch 28″ can be rotated downwardly and inwardly toward the side wall 14B″ of the body 14″ to create a retaining force exerted by the at least one locking latch 28″ on the lid 16″ in order to retain the lid 16″ on the body rim 14C″. To release the at least one locking latch 28″, the lever 28B″ may be rotated outwardly and upwardly with respect to the side wall 14B″ of the body 14″ to release the retaining force. Once in this position, the hook 28A″ of the at least one locking latch 28″ can be removed from engagement with the hook-shaped top portion of the latching post 16A″ to enable the lid 16″ to be removed from engagement with the body rim 14C″.

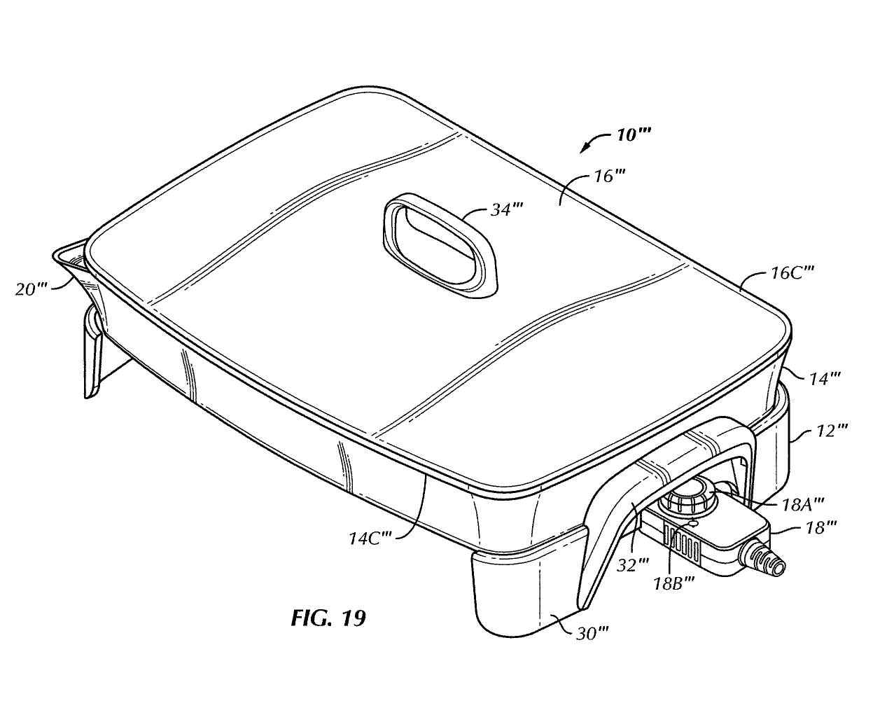

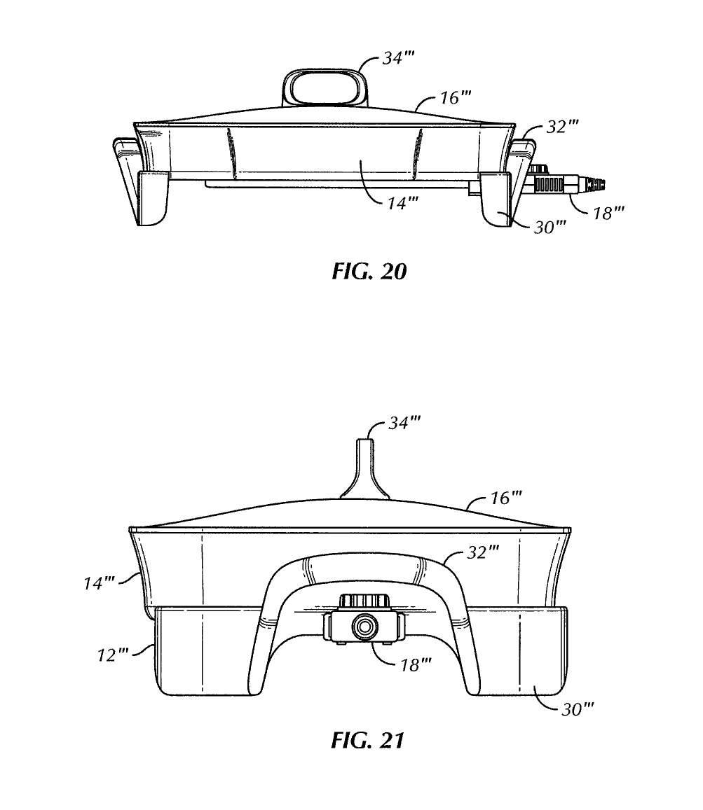

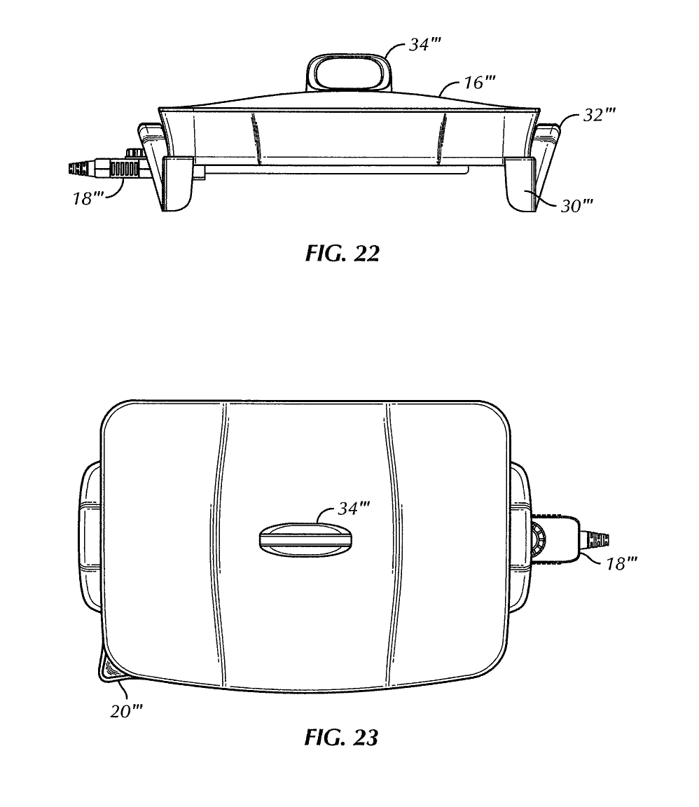

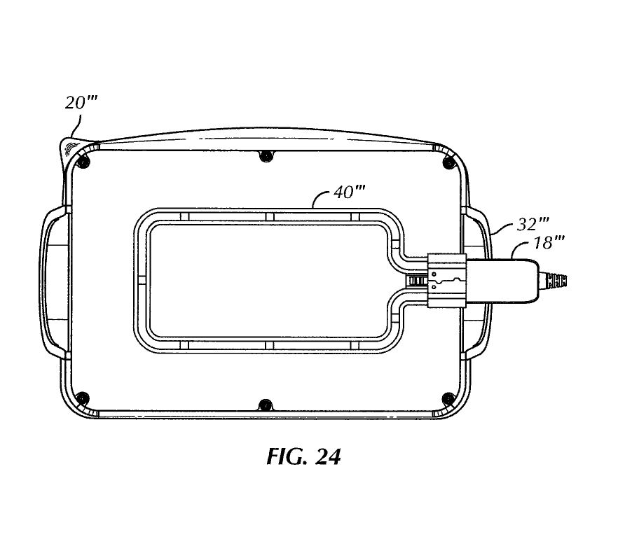

Referring to FIGS. 19-24, a fourth preferred embodiment of the kitchen appliance 10′″ is shown, including like reference numerals to indicate like elements and three prime symbols (′″) distinguishing the reference numerals of the fourth preferred embodiment from the first, second and third preferred embodiments. The fourth preferred embodiment of the kitchen appliance 10′″ is substantially similar to the second preferred embodiment of the kitchen appliance 10′. Similar to the other preferred embodiment, the fourth preferred embodiment of the kitchen appliance 10′″ is used for heating foodstuff. The kitchen appliance 10″ of the fourth preferred embodiment also includes a base 12′″, a body 14′″, a lid 16″, and a temperature probe 18′″. Further, the body 14′″ of the fourth preferred embodiment also includes a pour spout 20′″, similar to the other preferred embodiment of the kitchen appliance 10, 10′, 10″. The kitchen appliance 10′″ of the fourth preferred embodiment also includes a heating element 40′″ similar in size, shape, location and function to that of the other preferred embodiments 10, 10′, 10″. However, the kitchen appliance 10′″ of the fourth preferred embodiment preferably does not include a particle strainer, a particle stopper, pivotable body handles, latching posts or locking latches. It is understood that the fourth preferred embodiment may incorporate any one or more of these features without departing from the broad inventive concept thereof. Further, the lid 16′″ of the fourth preferred embodiment preferably does not extend to cover the pour spout 20′″ of the body 14′″ and the temperature probe 18′″ extends from the body 14′″.

As seen in FIGS. 19-24, handles 32′″ of the kitchen appliance 10′″ of the fourth preferred embodiment are molded onto the side portions of the body 14′″ and the base 12′″. The kitchen appliance handles 32′″ of the fourth preferred embodiment of the kitchen appliance 10′″ are not pivotably mounted to the body 14′″ or the base 12′″. Further, the lid handle 34′″ of the lid 16′″ is sized and shaped similarly to the lid handle 16B′ of the second preferred embodiment.

It will be appreciated by those skilled in the art that changes could be made to the embodiments described above without departing from their broad inventive concept thereof. It is understood, therefore, that this invention is not limited to the particular embodiments disclosed, but is intended to cover modifications within the spirit and scope of the present invention as defined by the appended claims.

I/We claim:

1. A kitchen appliance for heating foodstuff, said appliance comprising:
a body having a bottom, a side wall extending therefrom to define a generally hollow interior and a body rim defining an opening for accessing said interior thereof, said interior being capable of retaining said foodstuff therein; said body including a pour spout integrally formed in said side wall and a heating element in a thermal relationship with and integrally formed with said body to heat said foodstuff within said body, and
a lid removably mountable to said body rim of said body, said lid being sized and shaped to cover said opening of said body when placed on said body rim.

2. The kitchen appliance of claim 1, wherein said lid includes one of an integrally formed particle strainer and an integrally formed particle stopper at a location which is in registry with the pour spout when the lid is located on the body.

3. The kitchen appliance of claim 1, further comprising:
a base permanently mounted to said bottom of said body to support said body; said body including a temperature probe operatively mounted to said body.

4. The kitchen appliance of claim 3, wherein the temperature probe includes a temperature set dial and a light emitting device.

5. The kitchen appliance of claim 1, wherein said appliance is a skillet.

6. The kitchen appliance of claim 1, wherein said pour spout outwardly extends beyond said side wall of said body.

7. The kitchen appliance of claim 1, wherein said body further includes at least one body handle

8. The kitchen appliance of claim 1, wherein said at least one body handle is pivotably mounted to said side wall of said body.

9. The kitchen appliance of claim 7, wherein said lid further includes at least one latching post and at least one locking latch pivotably mountable on at least a portion of said body handle to securely attach said lid onto said body through selective releasable engagement with said at least one latching post.

10. The kitchen appliance of claim 1, wherein the pour spout is integrally formed at a corner of said side wall.

11. A kitchen appliance for heating foodstuff, said appliance comprising:
a base having a top surface and a bottom surface;
a body having a bottom, a side wall extending therefrom to define a generally hollow interior and a body rim defining an opening for accessing said interior thereof, said interior being capable of retaining said foodstuff therein; said bottom of said body integrally formed with said top surface of said base;
a heating element in a thermal relationship with said bottom to heat said foodstuff within said body,
a lid removably mountable to said body rim of said body, said lid being sized and shaped to cover said opening of said body when placed on said body rim; and
at least one locking latch pivotably mountable on at least a portion of said body to securely attach said lid to said body.

12. The kitchen appliance of claim 11, wherein said body further includes at least one body handle mounted to said side wall of said body; said at least one locking latch pivotably mountable on at least a portion of said at least one body handle.

13. The kitchen appliance of claim 12, said lid further includes at least one latching post, said at least one locking latch removably engagable to said at least one latching post to securely attach said lid to said body.

14. The kitchen appliance of claim 13, wherein said base further includes a temperature probe operatively mounted to said body and at least two feet extending from said bottom surface.

15. The kitchen appliance of claim 14, wherein said temperature probe includes a temperature set dial and a light emitting device.

16. The kitchen appliance of claim 15, wherein said appliance is a skillet.

17. The kitchen appliance of claim 16, wherein said body further includes a pour spout integrally formed at one corner of said side wall.

18. The kitchen appliance of claim 17, wherein said lid further includes one of a particle strainer and particle stopper integrally formed at a corner of said lid.

19. The kitchen appliance of claim 18, wherein said side wall and said lid are complimentarily sized such that said pour spout and said strainer are in registry when said lid is positioned on said body.
